(19) United States
(12) Patent Application Publication
(10) Pub. No.: US 2024/0403845 A1
(43) Pub. Date: Dec. 5, 2024

(54) SYSTEM FOR RECORDING AND CONSTRUCTING A SEMIOTIC WAGERING/AGREEMENT

(71) Applicant: Shango Pty Ltd, Kelvin Grove (AU)

(72) Inventors: Finbar O'HANLON, Kelvin Grove (AU); Alexander Tane von KANEL, Kelvin Grove (AU); Andrew LESAGE, Kelvin Grove (AU); Neil Steven PARTON, Kelvin Grove (AU); Kevin ROWLAND, Kelvin Grove (AU)

(21) Appl. No.: 18/675,880

(22) Filed: May 28, 2024

(30) Foreign Application Priority Data
May 29, 2023 (AU) 2023901675

(51) Int. Cl. G06Q 20/10; G06F 40/279; G06Q 20/06; G06Q 50/34; H04L 51/02; H04L 51/04

(52) U.S. Cl. CPC G06Q 20/10; G06F 40/279; G06Q 20/065; G06Q 50/34; H04L 51/02; H04L 51/04

(57) ABSTRACT

A system for recording and constructing a semiotic wagering/agreement is provided. The system comprises a communication interface (106) including: (i) a chat module (114) enabling chat messaging between at least a first and second user; (ii) a drafting module (107) monitoring chat messages, detecting keywords for agreement terms, and drafting terms based on these keywords; (iii) a referee designation module (108) suggesting draft terms for agreement if parties disagree; (iv) a transaction processing module (109) facilitating transactions based on agreement terms; (v) an escrow account module (110) holding funds until the wager's outcome is determined; and (vi) a payment gateway module (111) processing transactions and transferring funds. The system allows users to wager on various subjects by incorporating odds into contracts. Users communicate via devices connected to a server (101) with a processor (102), memory (103), and data storage (104), optionally including a business logic system.

### TECHNICAL FIELD

The present invention relates to the field of digital smart contracts, and more specifically to a system for recording and constructing a semiotic wagering/agreement.

### BACKGROUND

An agreement refers to an arrangement, often formal and written, between two or more groups or people. The agreements are generally entered between the parties after a series of negotiations and finally agreeing on a set of terms. These agreements are typically typed in a given format, signed and stored as paper documents. These agreements could also be typed, signed and stored in a computer, however, the data therein cannot be analyzed or utilized electronically. With the advent of technology and most of the working systems being digitized, there are available various software applications providing standardized templates for preparing and generating executable agreements. Most recent development in this field is the automation and execution of agreements using blockchain technology. Such agreements are referred to as ‘smart contracts’. A ‘smart’ contract refers to a computer program or a transaction protocol that is intended to automatically execute, control or document events and actions according to the terms of a contract or an agreement. Accordingly, digitally creating a ‘smart contract’ would still require an expert to be hired by the two parties to draft and digitize the agreement. Therefore, as such technologies are still in developmental stage, most of the times, a user would still execute and manage the agreement in a traditional manner.

US Patent Publication No. US 20210374672A1 to DocuSign Inc. discloses a system and method for the formation and post-formation versioning and management of computable contracts, including data-driven contracts. It discloses a system and method that provides stateful management, versioning, and storage of computable contracts and recording of input/output events from data-driven contracts and state changes, performance of transactions, and any other operations and events (e.g., recording of notice, termination etc.).

U.S. Pat. No. 11,301,619B2 to Zensar technologies Ltd. discloses method for transforming a contract into a digital contract for deployment over a decentralized platform. The method comprises processor implemented steps for receiving data from a user device, wherein the data corresponds to a set of clauses of a contract to be signed between two or more entities. The system uses blockchain and artificial intelligence to automatically execute contracts. The system is configured to capture the intent, milestones and events of a contract in smart contract codes. The digital contract is compiled and deployed on to a blockchain network.

US Patent Publication No. US20170287090 to Clause Inc. discloses a system and method that includes providing a contract management platform; constructing a data-driven contract with a set of programmable clauses by: receiving specification of a programmable clause, configuring programmable logic of the programmable clauses, mapping a set of integrations to the programmable clause, wherein at least one integration is a blockchain/distributed ledger integration, and adding at least one clause with natural language content; and executing the data-driven contract.

The agreements may be entered between two parties for various works. For example, an agreement entered into between parties under the condition that money is payable by the first party to the second party on the happening of a future uncertain event, and the second party to the first party when the event does not happen, are called a Wager. Similarly, the agreements may be for freelancing works provided by individuals on contract basis and other such related work. At present, the peer-to-peer wagering methods lack an efficient and transparent platform that enables users to easily retrieve and verify the details of their wagers. These methods often involve manual documentation, potential disputes, and a lack of standardized processes for resolution. Therefore, there is a need for an improved solution that leverages a semiotic covenant network to streamline the wagering process, retrieve wager details from chat conversations, provide automated or referee-based verification, ensure transparency and fairness in dispute resolution, and enhance trust and collaboration between users.

Similarly, current methods of creating and managing insurance covenants lack a streamlined and efficient platform that facilitates effective communication and negotiation between users seeking insurance coverage and insurance providers. These methods often involve time-consuming exchanges of emails and phone calls, resulting in delays, miscommunication, and limited customization options. Consequently, there is a need for an improved solution that enables users to input their insurance requirements using semiotic prompts, connects them with relevant insurance providers, facilitates transparent communication and negotiation, generates comprehensive insurance covenants, streamlines payment processes, simplifies claims handling, and provides valuable data for analysis and continuous improvement.

Various other digital platforms which may be made more user-friendly to provide a well-systematized solution include: a) the platforms for job request and contractor communication platforms where a structured and comprehensive is required so that the users are able to effectively communicate their job requirements and select suitable contractors; b) fundraising and crowdsourcing platforms where a transparent, and efficient system will empower donors to determine their donation amounts, ensure secure transactions, and offer real-time progress tracking; c) ticketing systems where a simplified ticketing process is desired which will ensure transparent transactions and efficient event management.

Thus, the existing digital platforms fail to provide a streamlined process for creating, finalizing, and managing covenants/agreements, resulting in inefficiencies, disputes, and a lack of confidence in the covenant outcomes. Furthermore, the absence of standardized methods for verification and resolution further hampers trust and collaboration among involved parties. Thus, there is a pressing need for an innovative solution that combines robust API integration and the involvement of third-party referees to streamline covenant/agreement finalization, enhance transparency, and foster trust.

Any discussion of the prior art throughout the specification should in no way be considered as an admission that such prior art is widely known or forms part of common general knowledge in the field.

### SUMMARY

### Problems to be Solved

As discussed above in the background section that the digital landscape lacks a unified platform that effectively addresses the challenges of trust, transparency, and consensus building in agreements. Therefore, it is desirable to provide a system and method that enables users to create, finalize, and manage covenants with ease, transparency, and confidence, ultimately fostering trust and collaboration in the digital landscape.

It is an objective of the invention to provide a digital platform which enables effective user communication for recording and constructing a semiotic wagering/agreement.

It is an object of the invention to provide a system to record and draft a semiotic wagering/agreement.

It is an object of the invention to provide a system and method to record and draft a semiotic wagering/agreement which involves effective user communication such as by symbolic/graphical representation to enhance the user experience.

It is an object of the invention to provide a system and method to record and draft a semiotic wagering/agreement which involves designating a referee from a pre-selected list or agree on a neutral party. The referee is responsible for ensuring fair play, resolving any disputes that may arise, and overseeing the wagering/agreement process.

It is an object of the invention to provide a system and method to record and draft a semiotic wagering/agreement involving technology-enabled features for the same.

It is an object of the present invention to overcome or ameliorate at least one of the disadvantages of the prior art, or to provide a useful alternative.

### Means for Solving the Problem

In a first aspect of the present invention, there is provided a system for recording and constructing a semiotic wagering/agreement wherein the said system comprises of a communication interface further comprising a chat module enabling chat messaging communication between at least a first and second user, a drafting module that monitors the chat messaging communication and detects keywords stating agreement terms and agreeance of each party where the drafting module predicts and drafts terms for the agreement based on agreed keywords, a referee designation module which will suggest multiple draft terms to each user for agreeance and feed these draft terms back into the chat module if the parties are unable to agree, a transaction processing module facilitating the processing of transactions based on agreement terms, an escrow account module for holding the transacted funds until the outcome of the wager is determined and releasing funds to the appropriate party, a payment gateway module processing transactions between users and transferring funds to the appropriate party, where the system for recording a semiotic wagering agreement allows the users to effectively wager on various subjects by determining and incorporating odds into contracts based on the agreement terms, and where one or a plurality of users are in communication with this communication interface via user devices and the plurality of users are further connected to a server via a network, where the server has a processor, a memory, and a data storage device and optionally a business logic system.

Preferably, the communication interface may reside within an application such as a chat application wherein the application comprises a business logic system.

Preferably, the chat application (201) performs certain preformed actions (202) wherein the preformed actions (202) include various menus such as but not limited to:/settings, /wager, /symbols, /list, /agreement, /custom and other suitable actions wherein these actions help provide the user(s) an interactive interface/platform to choose the keywords/terms/conditions of the wager/agreement.

Preferably, the referee could be either automatically assigned as to the type of wager, be a single source or hybrid combination of information sources where statistics reside, typically accessed via an API, or a moderator in which both parties agree is the trusted resource.

Preferably, the smart contract is monitored by the system for its agreed time via a timer (210) and during which time, notifications (213) and QR code (214) may be communicated to the users through the chat application (215) and/or email (216).

Preferably, the system may further be integrated with other applications.

Preferably, the system further incorporates additional features, such as rankings, leaderboards, and rewards for users who successfully complete wagers.

Preferably, the server is a central server and multiple user devices are connected to the server via a network or encompassed in layers within an application.

Preferably, the system further incorporates smart contracts to automatically reconcile transactions through the API.

Preferably, the system uses payment gateways to process transactions between users.

Preferably, the system uses cryptocurrencies, such as Bitcoin or Ethereum, to reconcile transactions.

Preferably, the system reconciles transactions manually wherein if there is a dispute or issue with the wager, the designated referee manually reviews the transaction and determines the appropriate outcome wherein the system provides tools and resources to assist with manual reconciliation, such as transaction histories and dispute resolution mechanisms.

Preferably, the system optionally performs additional functions, such as rankings, leader-boards, and rewards for users who successfully complete wagers to incentivize the users to continue participating in the network and improve the user experience.

### BRIEF DESCRIPTION OF THE FIGURES

FIG. 1 depicts a block diagram of components of a system in accordance with some embodiments of the present invention.

FIG. 2 depicts a dataflow diagram for in accordance with some embodiments of the present invention.

### DETAILED DESCRIPTION OF THE INVENTION

Preferred embodiments of the invention will now be described with reference to the accompanying drawings and non-limiting examples.

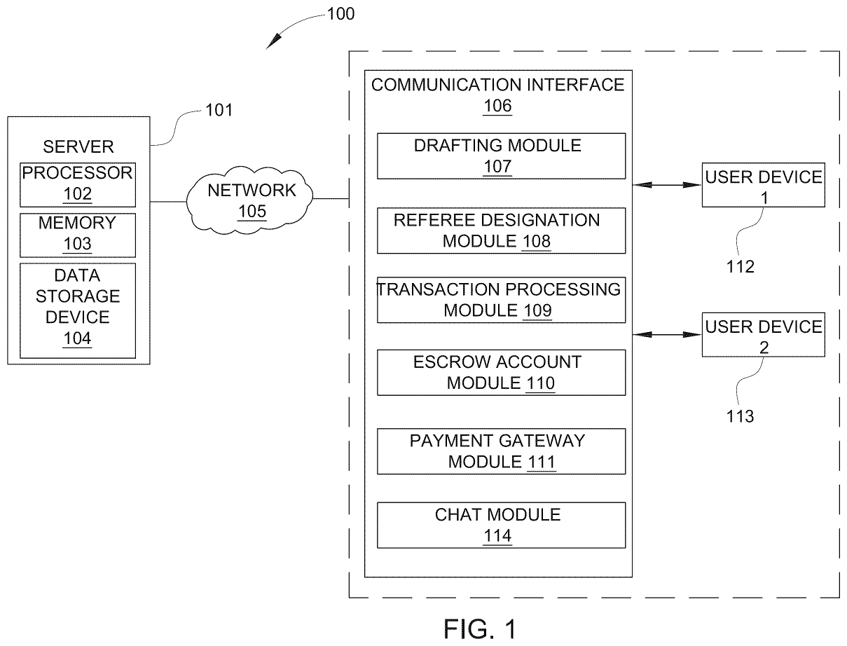

In an embodiment of the invention there is provided a system for recording and constructing a semiotic wagering/agreement. The said system as depicted in FIG. 1 comprises of a communication interface (106) which is comprising: i) a chat module (114) enabling chat messaging communication between at least a first and second user; (ii) a drafting module (107) that monitors the chat messaging communication and detects keywords stating agreement terms and agreeance of each party—where the drafting module predicts and drafts terms for the agreement based on agreed keywords; (iii) if the parties are unable to agree, a referee designation module (108) will suggest multiple draft terms to each user for agreeance and feed these draft terms back into the chat module; (iv) a transaction processing module (109) facilitating the processing of transactions based on agreement terms; (v) an escrow account module (110) for holding transacted funds until the outcome of the wager is determined and releasing funds to the appropriate party; (vi) a payment gateway module (111) processing transactions between users and transferring funds to the appropriate party; wherein the system for recording a semiotic wagering agreement allows the users to effectively wager on various subjects by determining and incorporating odds into contracts based on the agreement terms. Further, the users having user device 1 (112) and user device 2 (113) are in communication with this communication interface (106) and are further are connected to a server (101) via a network (105), wherein the server (101) has a processor (102), a memory (103) and a data storage device (104).

In an embodiment of the invention the communication interface (106) may reside within an application. One example is a chat application.

Semiotics refers to the systematic study of sign processes and meaning making. Semiosis is any activity, conduct, or process that involves signs, where a sign is defined as anything that communicates something, usually called a meaning, to the sign's interpreter. In the context of a wagering/agreement system of the present invention, semiotics uses signs combines with Natural language as a combined set of instructions that informs and directs the system to perform results and or provide output that has meaning to one or a number of users interacting with the system of the present invention.

As illustrated in FIG. 1, the users 1 and 2 using the user devices 1 (112) and user device 2 (113) respectively connect with the communication interface (106) firstly through the chat module (114) wherein the users input the desired data in form of keywords and other such formats, which data is fed into the drafting module (107). The drafting module (107) predicts and drafts terms for the agreement based on agreed keywords. The referee designation module (108) may be utilised by the users to designate a referee to ensure fair play and resolve any disputes that may arise. The referee designation module (108) then suggests multiple draft terms to each user for agreeance and feed these draft terms back into the chat module. The transaction processing module (109) of the communication interface (106) works to facilitate the processing of transactions based on agreement terms. Further, the escrow account module (110) holds the funds for the wager/agreement until the outcome is determined while, the funds are released to the appropriate party via the payment gateway module (111) which processes the transactions between users and transfers funds to the appropriate party.

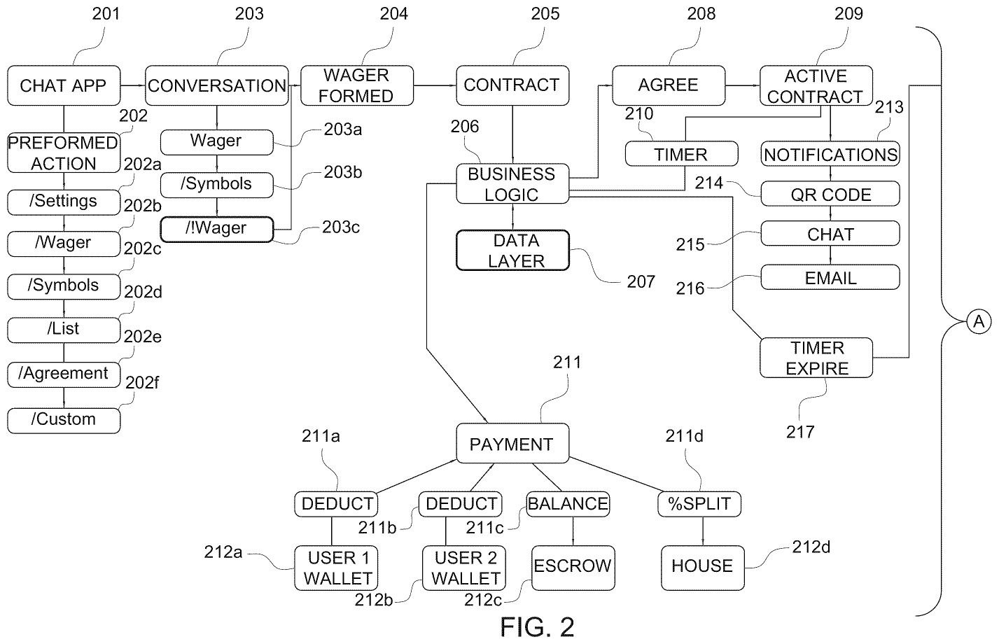

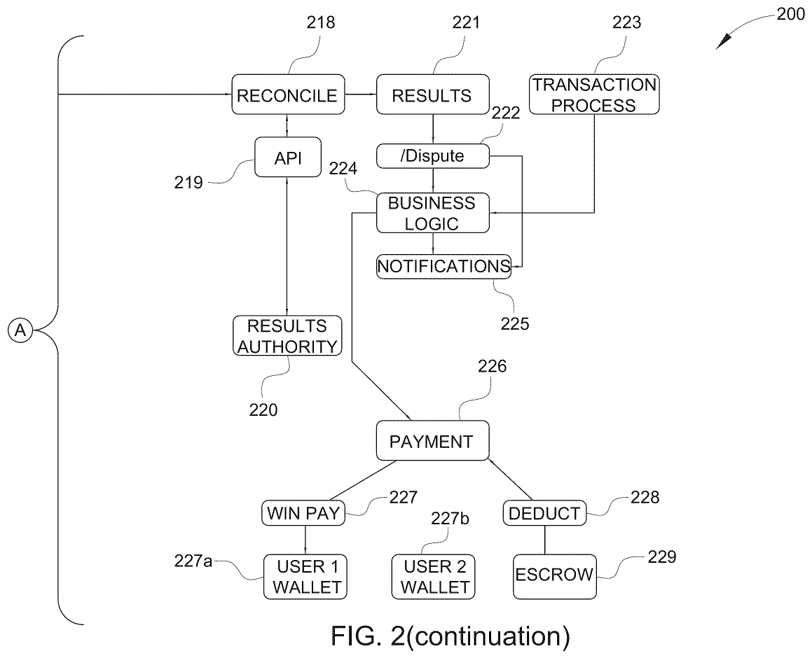

Referring now to FIG. 2 which is illustrating a dataflow diagram for in accordance with some embodiments of the present invention. As depicted in FIG. 2, a user or multiple users first interact with a chat application (201). This chat application (201) is able to perform certain preformed actions (202) wherein the preformed actions (202) may include various menus such as but not limited to: /settings, /wager, /symbols, /list, /agreement, /custom and other suitable actions wherein these actions help provide the user(s) an interactive interface/platform to choose the keywords/terms/conditions of the wager/agreement. Thus, during the conversation (203) in the chat app/application (201), the user may select for example from the/wager (203a) with a/symbol (203b): as /!wager (203c). The/wager contains multiple wagering functions designated by preceding symbol e.g. !Wager=place bet; £Wager=reconcile all bets. Preceding symbols are described in/symbols menu or could be defined in/custom. This kind of a semiotic wagering/agreement interface incorporates various symbols and graphical representations to enhance the user experience and provide instruction, direction and action. As the wagering/agreement conditions are finalised by the users, a referee may be designated to ensure fair play and resolve any disputes that may arise. The referee could be either automatically assigned as to the type of wager, be a single source or hybrid combination of information sources where statistics reside, typically accessed via and API, or a moderator in which both parties agree is the trusted resource. Once a wager (204) is formed, a smart contract (205) is constructed in the business logic system (206) of the application or server environment with the agreed (208) conditions. The system incorporates a data layer. This layer can incorporate a number of different components including encryption, authentication, timestamping, smart contracts, blockchain integration, event monitoring, and audit trail features. Using a plurality of these functions enables a wagering process that can be facilitated securely and transparently. The data layer promotes trust among the involved parties, provides a fair and accountable environment, and minimizes the potential for disputes or manipulation of data. The Data layer components consist of Data Transmission: The data layer acts as a reliable communication channel between the two parties and the referee. It facilitates the secure exchange of information related to the wager, such as bet details, participant identities, and transaction data. The layer ensures data integrity and confidentiality during transmission.

Encryption and Authentication: To maintain data security, the data layer employs robust encryption techniques to encrypt sensitive information while it is in transit. Additionally, it implements authentication mechanisms to verify the identities of the participating parties and the referee, preventing unauthorized access to the data.

Timestamping and Data Verification: The data layer incorporates timestamping mechanisms to record the exact time when each piece of data is received or updated. This feature helps establish the chronology of events and resolves any disputes regarding the sequence of actions. Furthermore, the layer allows for data verification to ensure that the transmitted data has not been tampered with or modified in transit.

Smart Contracts and Blockchain: To enforce the terms of the wager and automate certain processes, the data layer can utilize smart contracts. These self-executing contracts are encoded with predefined conditions agreed upon by all parties. The data layer can integrate with a blockchain network to store the smart contracts, transaction records, and other relevant data, ensuring immutability and transparency.

Referee's Role: The intermediate referee plays a vital role in the data layer. They act as a trusted third party responsible for validating the outcome of the wager. The referee receives and reviews the data provided by the participants, and based on predefined rules, determines the final outcome. The data layer ensures that the referee's decisions are transparent, unbiased, and accessible to all parties involved.

Event Monitoring: The data layer can include event monitoring capabilities to track and record all relevant events associated with the wager. It captures key actions such as bet placements, changes in odds, participant interactions, and referee decisions. This monitoring feature helps in auditing and resolving any disputes that may arise during or after the wager.

Audit Trail: The data layer maintains a comprehensive audit trail of all data exchanges, communications, and actions taken throughout the wager process. This trail serves as a historical record, enabling parties to review and verify the accuracy of the information exchanged, ensuring accountability and trust.

Compliance and Privacy: The data layer adheres to relevant data protection regulations and ensures compliance with privacy requirements. It implements measures to protect personally identifiable information (PII) and guarantees that only authorized individuals have access to the data

Thus, an active contract (209) is constructed. This active contract (209) is then monitored by the system for its agreed time via a timer (210) and during which time, the notifications (213) and QR code (214) may be communicated to the users through the chat application (215) and/or email (216). Once the smart contract is finalised, the users can use a software interface to place their bets. The software interface allows users to select the amount of the wager, as well as any conditions or rules that apply to the wager. The software interface also tracks the progress of the wager and notifies the referee and the users of any developments.

Further, in addition to facilitating wagers between users, the semiotic wagering/agreement system (200) may also incorporate additional features, such as rankings, leaderboards, and rewards for users who successfully complete wagers. The semiotic wagering/agreement system may also be integrated with other applications, such as social media or gaming platforms.

Furthermore, the semiotic wagering/agreement system comprises of either a central server and multiple user devices that are connected to the server via a network or encompassed in layers within an application. If the network is server based the server hosts a chat interface that allows users to communicate with one another and propose wagers. The chat interface supports various symbols and graphical representations to enhance the user experience. If application based the application uses a layered structure including a presentation, business logic, data (207) and payment (211) layered structure.

Furthermore, there may be provided number of methods in which the wagering/agreement system could be utilized. FIG. 2 also depicts some of the different methods. The system (200) could incorporate smart contracts to automatically reconcile (218) transactions through the API (219) which is in communication with the Results authority (220). Smart contracts are self-executing contracts with the terms of the agreement between the parties being directly written into lines of code. When certain conditions are met, such as a wager being completed, the smart contract would automatically execute the transaction, making payment (211) of the appropriate funds to the winning party through the application of business logic (206). On the other hand, the payment (211) may be deducted (211a and 211b) from the users 212a and 212b while the balance (211c) of the amount could be kept in an escrow account (212c) or the payment (211) could be split (211d) and kept in house (212d). Also, the semiotic wagering/agreement system (200) could use an escrow account to hold the funds for the wager until the outcome is determined. The escrow account would be managed by a third-party service or the designated referee, and the funds would be released to the appropriate party based on the outcome of the wager.

With the use of APIs, the system of the present invention is able to automate the verification of covenant outcomes, ensuring accuracy and efficiency. Simultaneously, incorporating third-party referees, chosen at the time of covenant creation, enables objective assessments in case of disputes, ensuring fair resolutions and consensus building. The system of the present invention enables the users to create, finalize, and manage covenants with ease, transparency, and confidence, ultimately fostering trust and collaboration in the digital landscape.

In some embodiments of the invention, the results (221) of the bet, if there is no dispute, then the business logic (224) is applied to the transaction process (223) for the payment (226) such as winning amount (227) may be made to the winning party (227a) and the amount deducted (228) from the escrow account (229) of the user 2 (227b). If the results (221) lead to a /dispute (222), then firstly, it will be notified (225) to the users and secondly, by application of the business logic (224), the payment (226) such as winning amount (227) may be made to the winning party (227a) and the amount deducted (228) from the escrow account (229) of the user 2 (227b).

In an aspect of the invention there is provided a system for recording and constructing a semiotic wagering/agreement wherein the said system comprises of a communication interface which is comprising: i) a chat module enabling chat messaging communication between at least a first and second user; (ii) a drafting module that monitors the chat messaging communication and detects keywords stating agreement terms and agreeance of each party—where the drafting module predicts and drafts terms for the agreement based on agreed keywords; (iii) a referee designation module which will suggest multiple draft terms to each user for agreeance and feed these draft terms back into the chat module, if the parties are unable to agree; (iv) a transaction processing module facilitating the processing of transactions based on agreement terms; (v) an escrow account module for holding transacted funds until the outcome of the wager is determined and releasing funds to the appropriate party; (vi) a payment gateway module processing transactions between users and transferring funds to the appropriate party; wherein the system for recording a semiotic wagering agreement allows the users to effectively wager on various subjects by determining and incorporating odds into contracts based on the agreement terms; and wherein one or a plurality of users are in communication with this communication interface via user devices and the plurality of users are further connected to a server via a network, wherein the server has a processor, a memory and a data storage device and optionally a business logic system.

In an aspect of the invention there is provided a system for recording and constructing a semiotic wagering/agreement wherein the communication interface may reside within an application such as a chat application wherein the application comprises a business logic system.

In an aspect of the invention there is provided a system for recording and constructing a semiotic wagering/agreement wherein the method of constructing a semiotic wagering/agreement includes the following steps: (a) at least one or a plurality of users using the respective user devices connects with the communication interface firstly through the chat module wherein the users input the desired data in form of keywords and other such formats, which data is fed into the drafting module; (b) the drafting module predicts and drafts terms for the agreement based on agreed keywords; (c) the referee designation module may be utilised by the users to designate a referee to ensure fair play and resolve any disputes that may arise wherein the referee designation module then suggests multiple draft terms to each user for agreeance and feed these draft terms back into the chat module; (d) once a wager is formed, a smart contract is constructed in a business logic system of the application or server environment with the agreed conditions; (e) the transaction processing module of the communication interface works to facilitate the processing of transactions based on agreement terms; and (f) the escrow account module holds the funds for the wager/agreement until the outcome is determined while, the funds are released to the appropriate party via the payment gateway module which processes the transactions between users and transfers funds to the appropriate party.

In an embodiment of the invention there is provided a system for recording and constructing a semiotic wagering/agreement wherein the chat application performs certain preformed actions wherein the preformed actions include various menus such as but not limited to: /settings, /wager, /symbols, /list, /agreement, /custom and other suitable actions wherein these actions help provide the user(s) an interactive interface/platform to choose the keywords/terms/conditions of the wager/agreement.

In an embodiment of the invention there is provided a system for recording and constructing a semiotic wagering/agreement wherein the referee could be either automatically assigned as to the type of wager, be a single source or hybrid combination of information sources where statistics reside, typically accessed via an API, or a moderator in which both parties agree is the trusted resource.

In an embodiment of the invention there is provided a system for recording and constructing a semiotic wagering/agreement wherein the smart contract is monitored by the system for its agreed time via a timer and during which time, notifications and QR code may be communicated to the users through the chat application and/or email.

In another embodiment of the invention there is provided a system for recording and constructing a semiotic wagering/agreement wherein the system may further be integrated with other applications.

In another embodiment of the invention there is provided a system for recording and constructing a semiotic wagering/agreement wherein the system further incorporates additional features, such as rankings, leaderboards, and rewards for users who successfully complete wagers.

In another embodiment of the invention there is provided a system for recording and constructing a semiotic wagering/agreement wherein the server is a central server and multiple user devices are connected to the server via a network or encompassed in layers within an application.

In yet another embodiment of the invention there is provided a system for recording and constructing a semiotic wagering/agreement wherein the system further incorporates smart contracts to automatically reconcile transactions through the API (application programming interface).

In yet another embodiment of the invention there is provided a system for recording and constructing a semiotic wagering/agreement wherein the system uses payment gateways to process transactions between users.

In yet another embodiment of the invention there is provided a system for recording and constructing a semiotic wagering/agreement wherein the system uses cryptocurrencies, such as Bitcoin or Ethereum, to reconcile transactions.

In yet another embodiment of the invention there is provided a system for recording and constructing a semiotic wagering/agreement wherein the system reconciles transactions manually wherein if there is a dispute or issue with the wager, the designated referee manually reviews the transaction and determines the appropriate outcome wherein the system provides tools and resources to assist with manual reconciliation, such as transaction histories and dispute resolution mechanisms.

In yet another embodiment of the invention there is provided a system for recording and constructing a semiotic wagering/agreement wherein the system optionally performs additional functions, such as rankings, leader-boards, and rewards for users who successfully complete wagers to incentivize the users to continue participating in the network and improve the user experience.

In another embodiment of the invention there is provided a digital platform which enables effective user communication, such as by symbolic/graphical representation to enhance the user experience, for recording and constructing a semiotic agreement.

In another embodiment of the invention there is provided a system and method to record and draft a semiotic wagering/agreement.

In another embodiment of the invention there is provided a system and method to record and draft a semiotic wagering/agreement involving technology-enabled features for the same

In the context of the present invention, the words “comprise”, “comprising” and the like are to be construed in their inclusive, as opposed to their exclusive, sense, that is in the sense of “including, but not limited to”.

The invention is to be interpreted with reference to the at least one of the technical problems described or affiliated with the background art. The present aims to solve or ameliorate at least one of the technical problems and this may result in one or more advantageous effects as defined by this specification and described in detail with reference to the preferred embodiments of the present invention.

In an embodiment of the invention the semiotic wagering/agreement system uses payment gateways to process transactions between users. Payment gateways act as a mediator between the semiotic wagering/agreement system and various payment systems, such as credit cards or digital wallets. When a wager/agreement is completed, the payment gateway would automatically process the transaction and transfer the funds to the appropriate party.

In an embodiment of the invention the semiotic wagering/agreement system uses cryptocurrencies, such as Bitcoin or Ethereum, to reconcile transactions. Cryptocurrencies use blockchain technology, which allows for secure and transparent transactions without the need for intermediaries. When a wager/agreement is completed, the appropriate amount of cryptocurrency would be transferred to the winning party's wallet.

In an embodiment of the invention the semiotic wagering/agreement system may need to reconcile transactions manually. For example, if there is a dispute or issue with the wager/agreement, the designated referee may need to manually review the transaction and determine the appropriate outcome. The semiotic wagering/agreement system could provide tools and resources to assist with manual reconciliation, such as transaction histories and dispute resolution mechanisms.

In an embodiment of the invention there is provided a semiotic wagering/agreement system which incorporates communication features and various symbols and graphical representations to enhance the user experience. Users can communicate with one another and propose wagers through a chat interface, which supports various symbols and graphical representations to enhance the user experience.

In an embodiment of the invention there is provided a semiotic wagering/agreement system in which prior to making a wager, users designate a referee from a pre-selected list or agree on a neutral party. The referee is responsible for ensuring fair play, resolving any disputes that may arise, and overseeing the wagering/agreement process.

In an embodiment of the invention there is provided a semiotic wagering/agreement system which may incorporate various technology-enabled features, such as smart contracts, payment gateways, and cryptocurrencies, to facilitate transactions and ensure fair play.

In an embodiment of the invention there is provided a semiotic wagering/agreement system which, additionally, may incorporate additional features, such as rankings, leader-boards, and rewards for users who successfully complete wagers. This incentivizes users to continue participating in the network and improves the user experience.

In the context of the present invention, the word ‘contract(s)’ is not limited to the legal sense of the word, and it may be a document, file or other mechanism which defines a set of behavior(s) that can be triggered under specified conditions. The word ‘contract’ may refer to a ticket for a train or airline, or for a concert venue, and on which is printed an access code such as a machine readable barcode for providing unlocking a barrier.

Further, it may be noted that any number of users may participate in creating a smart contract, such as there may be multiple users using multiple user devices. Furthermore, the user device may be any type of computing device such as a mobile phone, a desktop and other such devices. Furthermore, the server may include one or more server devices and/or other computing devices and the server, for example, may include a Web server, an application server, and/or a database.

Although the invention has been described with reference to specific examples, it will be appreciated by those skilled in the art that the invention may be embodied in many other forms, in keeping with the broad principles and the spirit of the invention described herein.

The present invention and the described preferred embodiments specifically include at least one feature that is industrial applicable.

1. A system for recording and constructing a semiotic wagering/agreement wherein the said system comprises of a communication interface which is comprising:
i) a chat module enabling chat messaging communication between at least a first and second user;
(ii) a drafting module that monitors the chat messaging communication and detects keywords stating agreement terms and agreeance of each party where the drafting module predicts and drafts terms for the agreement based on agreed keywords;
(iii) a referee designation module which will suggest multiple draft terms to each user for agreeance and feed these draft terms back into the chat module, if the parties are unable to agree;
(iv) a transaction processing module facilitating the processing of transactions based on agreement terms;
(v) an escrow account module for holding transacted funds until the outcome of the wager is determined and releasing funds to the appropriate party;
(vi) a payment gateway module processing transactions between users and transferring funds to the appropriate party;
wherein the system for recording a semiotic wagering agreement allows the users to effectively wager on various subjects by determining and incorporating odds into contracts based on the agreement terms; and
wherein one or a plurality of users are in communication with this communication interface via user devices and the plurality of users are further connected to a server via a network, wherein the server has a processor, a memory and a data storage device and optionally a business logic system.

2. The system for recording and constructing a semiotic wagering/agreement as claimed in claim 1 wherein the communication interface may reside within an application such as a chat application wherein the application comprises a business logic system.

3. The system for recording and constructing a semiotic wagering/agreement as claimed in claim 2 wherein the chat application performs certain preformed actions wherein the preformed actions include various menus such as but not limited to: /settings, /wager, /symbols, /list, /agreement, /custom and other suitable actions wherein these actions help provide the user(s) an interactive interface/platform to choose the keywords/terms/conditions of the wager/agreement.

4. The system for recording and constructing a semiotic wagering/agreement as claimed in claim 1 wherein the referee designation module could be either automatically assigned as to the type of wager, be a single source or hybrid combination of information sources where statistics reside, typically accessed via an API, or a moderator in which both parties agree is the trusted resource.

5. The system for recording and constructing a semiotic wagering/agreement as claimed in claim 1 wherein the system further incorporates smart contract(s) to automatically reconcile transactions through the API.

6. The system for recording and constructing a semiotic wagering/agreement as claimed in claim 5 wherein the smart contract is monitored by the system for its agreed time via a timer and during which time, notifications and QR code may be communicated to the users through a chat application and/or email.

7. The system for recording and constructing a semiotic wagering/agreement as claimed in claim 1 wherein the system may further be integrated with other applications.

8. The system for recording and constructing a semiotic wagering/agreement as claimed in claim 1 wherein the system further incorporates additional features, such as rankings, leaderboards, and rewards for users who successfully complete wagers.

9. The system for recording and constructing a semiotic wagering/agreement as claimed in claim 1 wherein the server is a central server and multiple user devices are connected to the server via a network or encompassed in layers within an application.

10. The system for recording and constructing a semiotic wagering/agreement as claimed in claim 1 wherein the system uses payment gateways to process transactions between users.

11. The system for recording and constructing a semiotic wagering/agreement as claimed in claim 10 wherein the system uses cryptocurrencies, such as Bitcoin or Ethereum, to reconcile transactions.

12. The system for recording and constructing a semiotic wagering/agreement as claimed in claim 11 wherein the system reconciles transactions manually wherein if there is a dispute or issue with the wager, the designated referee manually reviews the transaction and determines the appropriate outcome wherein the system provides tools and resources to assist with manual reconciliation, such as transaction histories and dispute resolution mechanisms.

13. The system for recording and constructing a semiotic wagering/agreement as claimed in claim 1 wherein the system optionally performs additional functions, such as rankings, leaderboards, and rewards for users who successfully complete wagers to incentivize the users to continue participating in the network and improve the user experience.
